(19) United States
(12) Patent Application Publication
(10) Pub. No.: US 2013/0100685 A1
(43) Pub. Date: Apr. 25, 2013

(54) LED LIGHTING ASSEMBLY WITH MOUNTING ELEMENT FOR OPTICS

(71) Applicants: Johannes Wilhelmus Weekamp, Beek En Donk (NL); Rob Bosma, Eindhoven (NL); Norbertus Antonius Maria Sweegers, Lierop (NL)

(72) Inventors: Johannes Wilhelmus Weekamp, Beek En Donk (NL); Rob Bosma, Eindhoven (NL); Norbertus Antonius Maria Sweegers, Lierop (NL)

(73) Assignee: KONINKLIJKE PHILIPS ELECTRONICS N.V., EINDHOVEN (NL)

(21) Appl. No.: 13/809,598

(22) PCT Filed: Jul. 12, 2011
(86) PCT No.: PCT/IB2011/053106

§ 371 Date: Jan. 11, 2013

(30) Foreign Application Priority Data
Jul. 14, 2010 (EP) 10169464.4

(51) Int. Cl. F21V 17/16

(52) U.S. Cl. CPC F21V 17/16
USPC 362/382; 29/464

(57) ABSTRACT

A lighting assembly, a mounting element and a manufacturing method are described. The lighting assembly includes an LED assembly 20 comprising an LED lighting element 14 provided on a carrier part 12. In order to mount an optical element 50 for forming an emission beam from light emitted from the LED lighting elements 14 a mounting element 30 is provided. The optical element 50 is mounted on the LED assembly 20 by this mounting element 30, which includes mount structure 32, clamps 44 for fixing the optical element 50, a positioning element 34 for positioning on the LED assembly 30 and an alignment part 40. The alignment part 40 comprises a flexible portion 36 and a first fixing part 46. The mount structure 32 comprises a second fixing part 48 movable relative to the first fixing part 46, which is arranged next to the first fixing part 46. The positioning element 34 is positioned on the LED assembly 20. A predetermined alignment may be achieved by fixing the first fixing part 46 to the second fixing part 48.

### FIELD OF THE INVENTION

The present invention relates to a mounting element for fixing an optical element to an LED assembly and to a lighting assembly including an LED assembly, a mounting element and an optical element.

### BACKGROUND OF THE INVENTION

LED (light emitting diode) lighting is increasingly used today, especially in automotive applications. While automotive signalling lamps, such as rear combination lamps are already widely realized with LED lighting elements, there are still few products available for LED automotive front lighting.

DE 10 2007 038 787 describes a lamp module with a semiconductor light source for use in an automobile headlight. A carrier part supports a semiconductor light source. A bent sheet metal part is provided comprising locking hooks for fixing an attachment optic element comprising a counter-catch section where the locking hooks are engaged in a final mounting position. Pins and corresponding bores are provided such that the attachment optic element is received in a defined position free of play.

### SUMMARY OF THE INVENTION

It is an object of the present invention to propose a mounting element, a lighting assembly and a method of producing a lighting assembly where a desired light distribution is easily achieved.

This object is achieved by a mounting element by claim 1, a lighting assembly according to claim 7 and a method of producing a lighting assembly according to claim 14. Dependent claims refer to preferred embodiments of the invention.

The present inventors have considered that for many lighting applications, and especially in automotive front lighting, a lighting assembly including a LED lighting element and an optical element need to be positioned quite exactly to achieve a desired emission beam, i. e. a desired spatial light distribution. Especially with regard to the small size of LED lighting elements and small distances between the lighting elements and corresponding optical elements, such as shades, lenses and collimators etc., any undesired offset, e. g. in Z-direction (central optical axis) or in X/Y directions perpendicular thereto as well as any rotation about the Z-axis and/or tilt with regard to this axis will result in undesirable optical effects. While it is in principal possible to obtain exact alignment by rigidly connecting elements of the lighting assembly produced with very low manufacturing tolerances, this may prove impractical and expensive. The present inventors have therefore considered that it is advantageous to provide a mounting element that has at least one flexible portion to allow mounting of an optical element to an LED assembly with a subsequent alignment process.

Accordingly, the mounting element is proposed according to the invention for fixing an optical element to an LED assembly. In the present context, an LED assembly refers to any element or groups of elements which comprise a single semiconductor diode, laser diode, OLED, or an array of such elements. An LED assembly may further include, besides an LED lighting element, also a carrier part, heat sink, electrical connection etc.

In the present context, an optical element may be any type of element that may serve for forming an emission beam from the light emitted from an LED lighting element. Thus, an optical element may comprise one or more of a shade, a lens, a reflector etc. Preferably, the optical element may comprise a lens and/or a reflector arrangement; in the preferred embodiment the optical element is a collimator comprising reflective collimator surfaces.

According to the invention, the mounting element comprises a mount structure, fixing means for fixing the optical element to the mount structure, at least one positioning element for positioning on the LED assembly and an alignment part connecting the mount structure to the positioning element. The fixing means provided may be any type of mechanical connection, such as e. g. pads or other surfaces for welding, gluing or soldering, or form-fit fixing means such as protrusions or recesses. In a preferred embodiment, the fixing means are clamps for clamping corresponding parts of the optical element.

A positioning element may be any part suited for positioning on, and preferably fixing on, the LED assembly. The positioning element may thus be any suitable surface, tab etc. In a preferred embodiment, the positioning element is a flat pad to be positioned on the LED assembly, preferably a welding pad to be fixed by a weld connection, preferably a laser weld.

The alignment part according to the invention comprises a flexible, i.e. deformable portion. Thus, the connection between the mount structure and the positioning element which is achieved by the alignment part is at least to a certain degree flexible due to the flexible portion of the alignment part. Thus, the resulting flexibility between the mount structure and the positioning element may be used to achieve alignment of the mount structure and the optical element fixed thereto relative to the positioning element and the LED assembly that this positioning element is positioned on. Accordingly, the relative position of the mount structure may be adjusted according to optical requirements until alignment is achieved.

According to the invention, there is further provided a possibility for fixing the alignment part in a desired position. To this end, the alignment part comprises a first fixing part and the mount structure comprises a second fixing part. The first and second fixing parts are arranged next to each other. Due to the flexible portion of the alignment part, the first and second fixing parts are moveable relative to each other.

If a correct alignment is achieved by a suitable adjustment (and corresponding flexible deformation of the flexible portion of the alignment part), it is possible to fix the mounting element in the aligned position by fixing the first and second fixing part to each other. This provides for a connection between the mount structure and the positioning element which is more rigid than the connection via the flexible portion of the alignment part.

In the lighting assembly according to the invention, the mounting element is used to mount the optical element to the LED assembly. A correct position of alignment between the LED assembly and the optical element may then by reached by adjusting the mounting element to a correct position where a desired optical alignment is achieved. This is possible due to the flexible portion of the alignment part. In this position, the mounting element may be “frozen” by fixing the first fixing part to the second fixing part, and thus achieving a rigid connecting between the mount structure and the positioning element.

The method according to the invention proposes to manufacture a lighting assembly by positioning a positioning element of the above mount structure to an LED assembly, “freezing” the position of the mounting element by fixing the first fixing part to the second fixing part, and fixing an optical element to the fixing means on the mounting elements. It should be noted that the steps mentioned in claim 14 do not necessarily have to be carried out in the order in which they are listed. For example, it is possible to fix the optical element to the mounting element before or after positioning and/or “freezing”. However, it is generally preferred to carry out the step of “freezing” (fixing the first fixing part to the second fixing part) after positioning the positioning element on the LED assembly.

Thus, according to the invention, a mounting element, lighting assembly and manufacturing method are provided which allow to a certain degree a flexible positioning of the optical element relative to the LED assembly, where however the lighting assembly may be “frozen” in an alignment position. Thus, a lighting assembly with high optical precision, such as required, e. g. for automotive front lighting, may be achieved despite possible manufacturing tolerances of individual parts. The lighting assembly is well suited for mass production.

According to a preferred embodiment of the invention, the mounting element comprises not only a single positioning element, but a plurality of such elements, such as at least three positioning elements arranged at a distance to each other to achieve a defined positioning.

It is preferred to provide at least some parts of the mounting element, further preferred all parts of the mounting element, to be made out of metal, especially bent sheet metal. Preferably, the alignment part is a sheet metal structure comprising at least one bend, further preferred at least two bends to form the flexible portion. The first and second fixing parts are preferably flat sheet metal elements positioned on each other, which may advantageously be fixed to each other by a weld connection, especially preferred a laser weld. Also, the positioning element may be a welding pad. To achieve a low part count, it is especially preferred to provide the mount structure, alignment part and positioning element as well as first and second fixing part integrally formed as bent sheet metal structure. The metal material for the mount structure may be e. g. steel, nickel or copper. The thickness may be e. g. 0.1-0.5 mm, preferably 0.2-0.4 mm.

According to the preferred embodiment, the optical element to be fixed to the LED assembly is a collimator comprising reflective collimator services for forming an emission beam. It is advantageous to provide a collimator with reflective surfaces and, further preferred, a window through which light from the LED element is emitted, close to the LED element. Preferably, the collimator surfaces are arranged bordering this window. The window may be formed in a separate window element mounted on the metal frame. Further preferred, the collimator has a shape where the collimator surfaces form a funnel, which is arranged such that light from the LED element is emitted through the funnel.

For mounting the optical element on the mounting element, alignment elements may be provided on the mounting element and/or on the collimator or its parts. For example, matching indentations, recesses and/or protrusions may be provided such that the collimator, or parts of the collimator are mounted on the mounting element in a defined position if these matching alignment elements are engaged.

### BRIEF DESCRIPTION OF THE DRAWINGS

The above and other objects, features and advantageous of the present invention will become apparent from the following description of preferred embodiments, in which

FIG. 1 shows a perspective view of an LED lighting assembly according to an embodiment of the invention;

FIG. 2 shows a front view of the lighting assembly according to FIG. 1;

FIG. 3 shows an exploded side view of the lighting assembly according to FIG. 1, FIG. 2;

FIG. 4 shows a perspective, exploded sectional view of the lighting assembly according to FIGS. 1-3 with the section taken along the line A . . . A in FIG. 2;

FIG. 5 shows an exploded perspective view of an optical element (collimator);

FIG. 6 shows a perspective view of a mounting element according to an embodiment of the invention;

FIG. 7 shows a perspective view of the mounting element of FIG. 6 with a mounted window element;

FIG. 8 shows a side view of the mounting element with the window element of FIG. 7 mounted on an LED assembly.

### DETAILED DESCRIPTION OF EMBODIMENTS

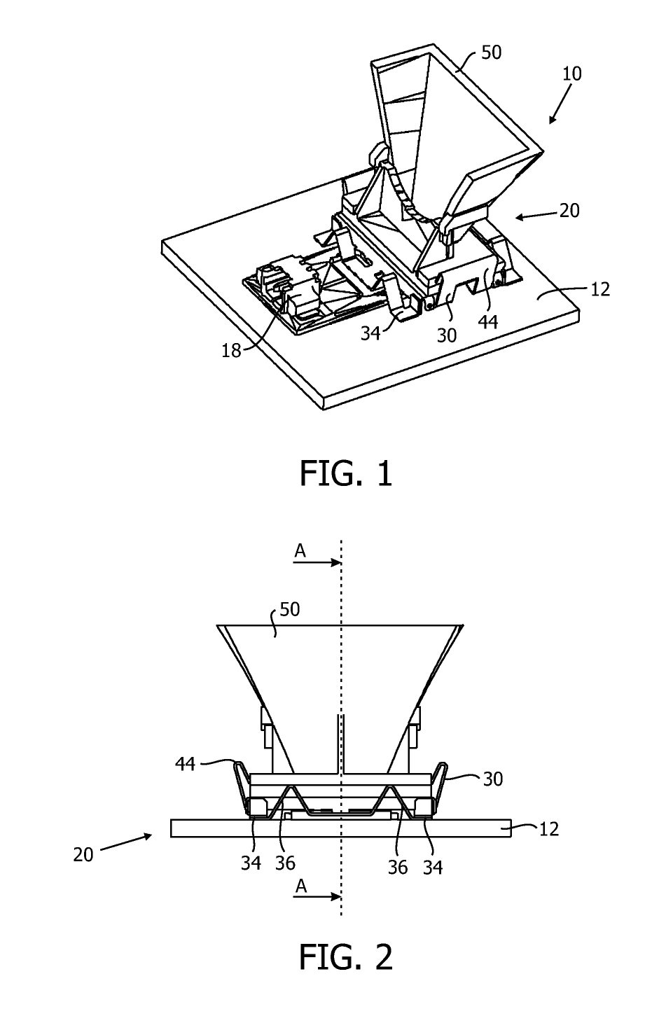

FIGS. 1-7 show a lighting assembly 10 comprising a carrier 12 with an LED element 14 mounted on a head spreader 16 fixed to the carrier 12 (see FIG. 9). Electrical leads are provided to an electrical connector 18. The LED element 14, head spreader 16 and carrier 12 will be referred to as LED assembly 20.

Mounted on the LED assembly 20 is a mounting element 30 holding a collimator 50 as an optical element.

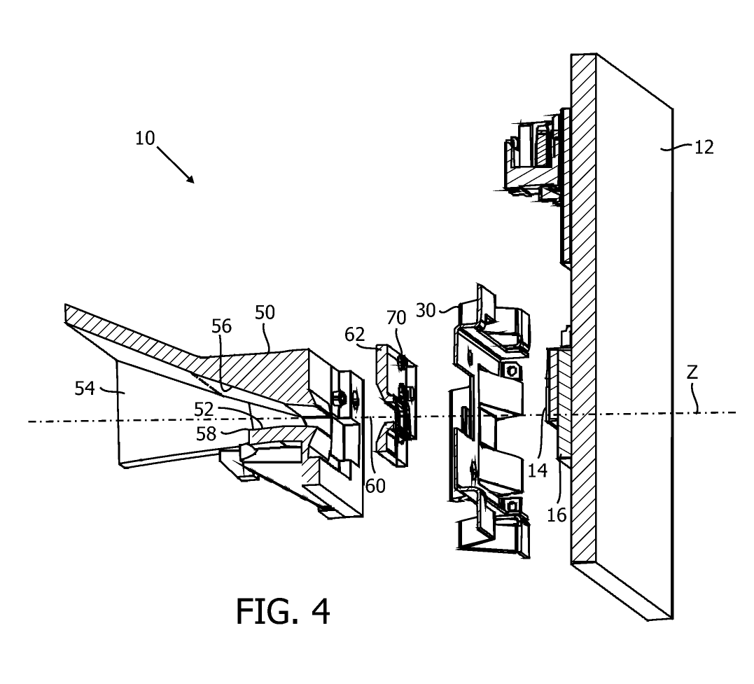

The LED element 14 emits light in a generally non-directional way (Lambertian emitter). The light emitted from the LED element 14 is shaped in the collimator 50 to form an emission beam with a desired angular intensity distribution. In the case of the collimator 50, a corresponding emission beam with a cut off (i. e. no light or at least very low intensity above a generally vertical cut off line and a high intensity below the cut off) as well as gradually decreasing intensity toward greater angles is formed by inner surfaces 52, 54, 56 and especially a cut off edge 58 of a first collimator surface 52 (see FIG. 4). The collimator surfaces 52, 54 and 56 are reflective surfaces. They lead up to a window 60 positioned close to the LED element 14. From this window 60, the collimator surfaces open to form a funnel. Thus, the light emitted from LED element 14 is—by partly shading light in some directions and reflecting light into other directions—shaped into the desired emission beam, which may advantageously be projected by a secondary optical element, such as a lens (not shown). The correspondingly shaped beam is, due to its cut off and the other aspects of its spatial intensity distribution well suited for automotive head lighting.

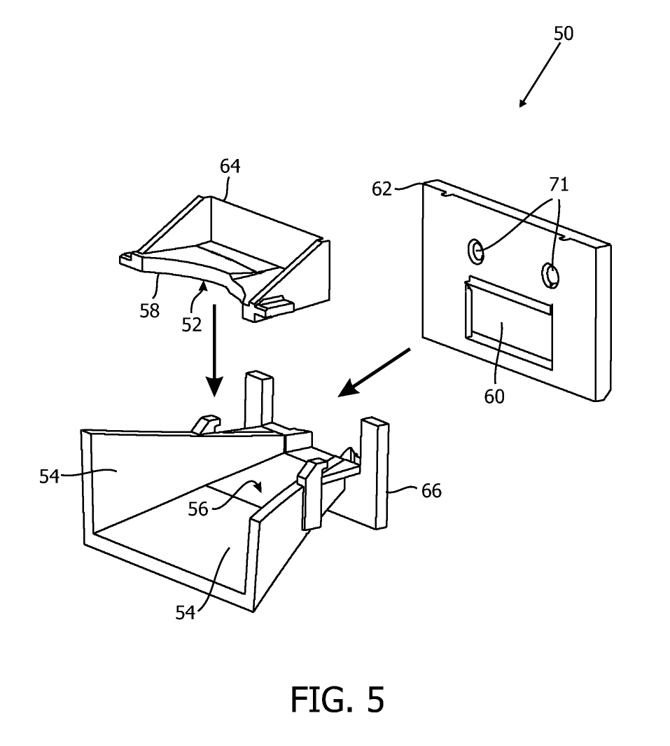

The collimator 50, as shown in the exploded view of FIG. 5, is comprised of three separate parts made of plastic: a window element 62 with the central window 60, a cut off element 64 with the first collimator surface 52 and the cut off edge 58, and a main funnel part 66 comprising a second collimator surface 56 and side collimator surfaces 54. As further shown, the parts 62, 64, 66 of the collimators have alignment protrusions or alignment holes 71 which serve to mount the parts in a defined way relative to each other. The window element further has alignment protrusions 70 on the backside (see FIG. 4) for alignment on the mounting element 30.

In the present embodiment of the invention, the collimator 50 is not mounted to the LED assembly 20 directly, but via the mounting element 30. The mounting element 30 holds the collimator 50 such that it is fixed with regard to the LED assembly 20, but allows, as will be explained in detail, to a certain degree an adjustment of the relative position of the collimator 50 and the LED element 14 to achieve a desired optical alignment.

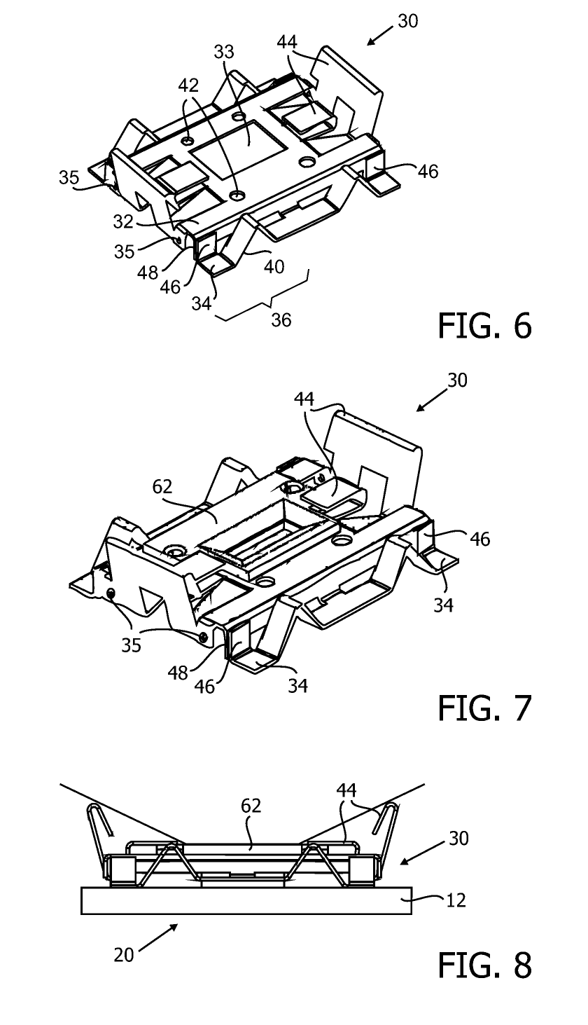

The mounting element 30 is shown in detail in FIGS. 6-8. The mounting element 30 is formed integrally as a single-body part of bent sheet metal, preferably in subsequent stamping and bending processes. The material and thickness of the sheet metal used is chosen such that the mounting element 30 has in some portions, which will be discussed below, a certain flexibility. In the preferred embodiment, the material used is a copper nickel alloy, preferably CuNi 10 with a thickness of 0.2 mm.

The mounting element 30 comprises a central mount structure 32 of flat and generally rectangular form with a central window 33. The mount structure 32 further has alignment holes 42 by which, as will be explained later on, exact alignment with the collimator 50 may be achieved.

Further, clamps 44 are provided on the mount structure 32, which clamps are formed from the same sheet metal material and serve to fix the parts of the collimator 50 to the mount structure 32.

On the short sides, the mount structure 32 comprises bent tabs with handling holes 35 provided to insert correspondingly shaped tools to allow easy handling of the mounting element 30.

On the long sides of the mounting structure 32, four alignment parts 40 are formed, which again are made from the same sheet metal material as the rest of the mounting structure 30 and are formed integrally therewith. Each alignment part 40 is formed as a deformable “leg” formed at the mount structure 32 and comprises a positioning pad 34. The mounting element 30 rests on four such positioning pads 34 on the carrier 12 of the LED assembly 20.

Flexible portions 36 are formed between the mounting pads 34 and the mount structure 32 by elongate tabs each comprising three bends in opposing directions out of the tab plane to form a V shape.

Adjacent to each positioning pad 34, and integrally formed therewith, is a tab acting as first fixing part 46 which is bent to be arranged in a direction perpendicular to the plane of the carrier 12. The mount structure 32 also comprises a corresponding adjacent tab, integrally formed therewith to act as second fixing part 48, which extends in generally the same direction as the first fixing part 46. The first and second fixing parts 46, 48 are therefore tabs arranged in parallel closely on top of each other.

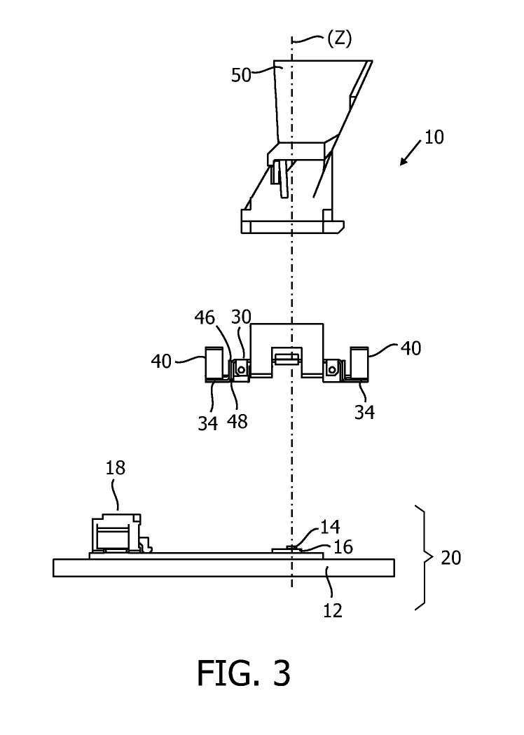

During mounting of the collimator 50, the legs, or alignment parts, 40 with their flexible portions 36 serve to provide a certain possibility of adjustment. As shown in the exploded views of FIG. 3, FIG. 4, the mounting element 30 is positioned on the carrier 12 of the LED assembly 20 with the mounting pads 34 positioned on the surface thereof. Positioning of the mounting element 30 is free on the LED assembly 20, such that it is possible to achieve an adjustment of the positioning thereof in X- and Y-direction (i. e. perpendicular to the central optical axis Z, which is perpendicular on the surface of the carrier 12 and runs through the centre of the LED element 14) as well as with regard to rotation about the Z-axis. As soon as adjustment in X, Y and rotation about Z is achieved, the positioning pads 34 are fixed to the carrier 12, e. g. by laser welding.

However, even after thus the positioning pads 34 are fixed, the mount structure 32 is still adjustable with regard to its position in Z-direction and with regard to its tilt angle to this Z-axis. This adjustment is made possible by the flexible portions 36. However, as the corresponding adjustment in Z- or tilt-direction is made, the first and second fixing parts 46, 48 will move relative to each other.

Due to the close relative arrangement of the overlapping tabs serving as first and second fixing parts 46, 48, the flexible, bendable arrangement of the mount structure 32 relative to the mounting pads 34 (and, since these are fixed to the carrier 12, also relative to the whole LED assembly 20) may be “frozen”, i.e. made rigid by fixing the first and second fixing parts 46, 48 to each other. This is preferably effected by a laser weld. After first and second fixing parts 46, 48 are thus fixed directly to each other, further relative movement, especially in the Z-direction is no longer possible (or meets at least a much stronger resisting force due to the now rigid connection). Now the legs, or alignment parts 40, together with the connection of the first and second fixing parts 46, 48 provide a relatively rigid connection between the mount structure 32 and the positioning pad 34.

During manufacture of the lighting assembly 10, preferably the first (window) part 62 of the collimator 50 is mounted on the mounting element 30 as shown in FIG. 7. Alignments protrusions 70 provided on the back of the window element 62 engage in alignment holes 42 in the mount structure 32. Additionally, the window element 62 is fixed by clamps 44.

The thus pre-assembled part as shown in FIG. 7 is then placed on the LED assembly 20 as shown in FIG. 8. The central window 60 of the window part 62 is adjusted in X, Y and rotation direction relative to the LED element 14 by correspondingly positioning the positioning pads 34 on the carrier 12. As soon as correct alignment is achieved, the positioning pads 34 are fixed to the carrier 12 by laser welding.

Then, further adjustment of the window part 62 relative to the LED element 14 is effected in Z and tilt direction, where the alignment parts 40, as explained above, serve to allow this adjustment. After correct alignment is reached, the alignment parts 40 are “frozen” in the alignment position found by effecting a laser weld connection between the first and second fixing part 46, 48.

Manufacture of the lighting assembly 10 is then completed by mounting the remaining collimator parts 64, 66 comprising alignment holes or alignment protrusions 71 which engage corresponding alignment holes and/or protrusions on other parts of the collimator.

Thus, a final lighting assembly 10 is achieved comprising as optical element the collimator 50 in a well-aligned orientation relative to the LED assembly 20.

During placing and adjustment the mounting element 30 may be held by tools inserted into handling holes 35.

Adjustment of the position of the mount structure 32 to a defined alignment position may be effected either passively, i. e. by adjusting the position according to a predetermined mechanical position. Alternatively, adjustment may be effected actively, i. e. by operating the LED light sources 14 and adjusting the position of the mount structure 32 according to the optical result achieved.

The invention has been illustrated and described in detail in the drawings and foregoing description. Such illustration and description are to be considered illustrative or exemplary and not restrictive; the invention is not limited to the disclosed embodiments. As the skilled person will appreciate, there are various alternatives to the disclosed embodiments. For example, the order of the steps carried out in assembly and adjustment of the elements of lighting assembly 10 may vary from the described order. Rather than effecting adjustment with only the window part 62 installed, adjustment may also be effected without a part of the collimator 50 installed, with other parts of the collimator 50 installed or with the complete collimator 50.

The collimator may be of different shape, and may be manufactured integrally rather than in three parts as explained. Further, while the preferred embodiment is intended to be used in automotive front lighting, the lighting assembly may also be used in other lighting applications.

In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. Mounting element for fixing an optical element to an LED assembly, comprising
a mount structure,
fixing means for fixing said optical element to said mount structure,
at least one positioning element for positioning on said LED assembly,
where said mount structure is connected to said positioning element by an alignment part,
and where said alignment part comprises a flexible portion which is deformable to allow aligning said mount structure relative to said LED assembly according to optical requirements, and a first fixing part
and said mount structure comprises a second fixing part, said first fixing part and said second fixing part being movable relative to each other due to said flexible portion,
said second fixing part being arranged next to said first fixing part, such that said first Fixing part and said second fixing part may be fixed to each other after alignment to provide a rigid connection.

2. Mounting element according to claim 1, where
a plurality of positioning elements is provided,
where said mount structure is connected to each of said positioning elements by an alignment part.

3. Mounting element according to claim 1, where
said alignment part is a sheet metal structure comprising at least one bend.

4. Mounting element according to claim 1, where
said first and second fixing parts are flat sheet metal elements positioned on each other.

5. Mounting element according to claim 1, where
said positioning element is a welding pad.

6. Mounting element according to claim 3, where said mount structure, said alignment part and said positioning element are formed integrally as a bent metal sheet structure.

7. Lighting assembly including
an LED assembly comprising an LED lighting element provided on a carrier part,
an optical element provided for forming an emission beam from light emitted from said LED lighting element,
where said optical element is mounted on said LED assembly by a mounting element according to claim 1,
and where said positioning element is positioned on said LED assembly,
and where said first fixing part is fixed to said second fixing part.

8. Lighting assembly according to claim 7, where
said positioning element is fixed to said LED assembly by a welding connection.

9. Lighting assembly according to claim 7, where
said first fixing part is fixed to said second fixing part by a welding connection.

10. Lighting assembly according to claim 7, where
said optical element is a collimator comprising reflective collimator surfaces for forming said emission beam.

11. Lighting assembly according to claim 10, where
said collimator comprises a window, arranged such that light from said LED element is emitted through said window.

12. Lighting assembly according to claim 11, where
said mounting element and said optical element comprise alignment elements,
where said alignment elements of said mounting element and of said optical element are engaged to obtain a defined position of said optical element.

13. Lighting assembly according to claim 10, where
said collimator surfaces form a funnel where light from said LED element is emitted through said funnel.

14. Method of manufacturing a lighting assembly, including
providing an LED assembly comprising an LED lighting element on a carrier part,
providing a mount structure connected to a positioning element by an alignment part, where said alignment part comprises a flexible portion, which is deformable to allow aligning said mount structure relative to said LED assembly according to optical requirements, and a first fixing part
and said mount structure comprises a second fixing part, said first fixing part and said second fixing part being movable relative to each other due to said flexible portion,
said second fixing part being arranged next to said first fixing part, such that said first Fixing part and said second fixing part may be fixed to each other after alignment to provide a rigid connection,
positioning said positioning element on said LED assembly
aligning said mount structure on said LED assembly to achieve a predetermined position and/or direction thereof relative to said LED assembly, and thereafter fixing said first fixing part to said second fixing part.
fixing an optical element to fixing means provided on said mount structure.

15. (canceled)
